(19) United States
(12) Patent Application Publication
(10) Pub. No.: US 2026/0349076 A1
(43) Pub. Date: Nov. 5, 2026

(54) Multi-Domain Signature Management System for Unmanned Aerial Vehicles

(71) Applicant: Vincent Loccisano, Wellesley, MA (US)

(72) Inventor: Vincent Loccisano, Wellesley, MA (US)

(21) Appl. No.: 19/707,851

(22) Filed: Jun. 15, 2026

(51) Int. Cl. G01S 7/36

(52) U.S. Cl. CPC G01S 7/36

(57) ABSTRACT

A unified multi-domain signature management system (MDSMS) for unmanned aerial vehicles (UAVs) is provided to simultaneously mitigate and manage five distinct signatures: radar cross-section, acoustic emissions, infrared thermal emissions, radio frequency emissions, and visual contrast. The system comprises a central controller featuring a Target Fusion Engine that processes multi-modal sensor data into a real-time Target State Vector, a Signature Priority Manager that dynamically allocates constrained power across the domains based on detected threat priorities, and a Constraint Satisfaction Solver that calculates jointly optimal countermeasure operating points while resolving cross-domain physical coupling conflicts. Controlling five specialized countermeasure subsystems under unified closed-loop control, the architecture utilizes a Signature Verification module for continuous real-time feedback. Furthermore, the system extends to swarm-level collective signature coordination without reliance on GPS or external infrastructure, enabling comprehensive multi-spectral stealth.

### FIELD OF INVENTION

The present invention relates generally to stealth and signature management systems for unmanned aerial vehicles (UAVs). More particularly, the invention pertains to a unified, multi-domain signature management system that simultaneously mitigates and manages five distinct electromagnetic and physical profiles: radar cross-section, acoustic emissions, infrared thermal emissions, radio frequency emissions, and visual/optical contrast. This is achieved through the integrated, closed-loop control of multiple countermeasure subsystems that dynamically resolve cross-domain physical constraints for both individual aircraft and coordinated multi-UAV swarms.

### BACKGROUND

Modern adversary integrated air defense systems (IADS) employ multiple, overlapping sensor modalities specifically designed to compensate for the limitations of any single detection technology. A contemporary IADS node may simultaneously operate an active radar system for primary detection and tracking of airframe return signals, a passive acoustic detection array for the detection of propulsion noise at short ranges, and an infrared search and track (IRST) system for the detection of thermal emissions from motors, batteries, and airframe solar loading. Furthermore, these systems frequently utilize electronic support measures (ESM) receivers to detect radio frequency (RF) emissions from communication and sensor payloads, alongside electro-optical surveillance systems for visual detection of the physical airframe against the sky background. Because each of these detection modalities targets a fundamentally different physical property of an unmanned aerial vehicle (UAV), defeating one modality while leaving others unaddressed provides only marginal operational benefit.

Consequently, the problem of signature management for UAVs is fundamentally a multi-domain optimization problem characterized by highly coupled sub-problems. Successfully managing a vehicle's multi-spectral footprint requires reducing each of the five signatures to levels below their respective detection thresholds, subject to the strict constraint that the countermeasures applied to reduce one signature do not inadvertently increase another. This coupling is a central technical challenge, as the constraints are numerous, physically diverse, and in some cases directly antagonistic. For example, activating a plasma sheath for radar cross-section (RCS) reduction imposes an RF silence requirement on co-located antennas, thermoelectric cooling for IR suppression consumes electrical power that directly competes with electronic warfare system operations, and rotor phase modifications for acoustic cancellation must remain within bounds that preserve flight stability.

Prior art systems fail to address this multi-domain signature management problem in its full complexity, as they are dominated by approaches addressing individual signature domains in isolation or, at most, two or three domains in loosely coupled configurations. While prior systems have introduced passive acoustic reduction through blade profile optimization, static infrared suppression coatings, or isolated RCS management without formation-geometry optimization, they leave the aircraft vulnerable to detection through the remaining unaddressed modalities. Furthermore, these loosely coupled systems do not implement a formal constraint satisfaction framework that automatically detects and resolves cross-domain physical coupling conflicts arising from incompatible simultaneous demands. They also lack closed-loop signature verification across all addressed domains, meaning countermeasures are commanded open-loop without measuring their achieved effect. Additionally, prior multi-domain signature management approaches are heavily dependent on GPS for absolute position knowledge to compute target bearings and formation geometries, which introduces a critical vulnerability in GPS-denied environments where adversary IADS capabilities are most advanced.

Accordingly, there exists a clear, unmet, and urgent need for a unified multi-domain signature management system that simultaneously addresses all five major UAV signature domains. An effective solution must detect and characterize targets across all domains through multi-modal sensor fusion, allocate constrained countermeasure resources through formal optimization, and verify achieved signature reduction through closed-loop sensor feedback in every domain. Furthermore, there is a critical need for a system that can operate entirely without GPS, ground control station connectivity, or external infrastructure, while successfully extending signature management to a swarm-level collective coordination framework.

### SUMMARY

The present invention provides a unified Multi-Domain Signature Management System (MDSMS) designed to dynamically manage and reduce the multi-spectral signatures of unmanned aerial vehicles (UAVs). Operating as a central controller, the MDSMS integrates real-time environmental data to simultaneously mitigate radar cross-section (RCS), acoustic emissions, infrared (IR) signatures, radio frequency (RF) emissions, and visual/optical contrast. The core system architecture relies on three primary processing modules: a Threat Fusion Engine (TFE) that aggregates data from five distinct sensor modalities using an IMM-EKF multi-hypothesis tracker to generate a comprehensive Target State Vector (TSV); a Signature Priority Manager (SPM) that allocates constrained power resources across the signature subsystems based on the specific type of threat detected; and a Constraint Satisfaction Solver (CSS) that calculates a jointly optimal countermeasure operating point by leveraging the Alternating Direction Method of Multipliers (ADMM) to rapidly resolve cross-domain physical coupling constraints in parallel.

To achieve this comprehensive mitigation, the MDSMS outputs coordinated commands to five specialized subsystems operating under closed-loop control. These include a Radar/RCS Management subsystem utilizing a segmented plasma sheath electrode layout and a Formation RCS Optimizer; an Acoustic Management subsystem employing shape-memory alloy blade morphing and multi-rotor phase synchronization; and an Infrared Signature Management subsystem that redistributes localized heat via a thermoelectric network while utilizing electrochromic panels to dynamically match the airframe's apparent temperature to the sky. Furthermore, an RF/EM Emission Management subsystem implements Low Probability of Intercept (LPI) protocols such as burst-mode transmission and covert channel encoding, while a Visual/Optical Stealth subsystem dynamically adjusts surface reflectance, disrupts condensation trails, and manages vehicle attitude to prevent sun glint.

System efficacy is continuously maintained through a Signature Verification Sensor Suite that measures the achieved signature reductions in each domain, feeding this data into a Signature Error Controller to actively diagnose, correct, and verify countermeasure performance. The system also features swarm-level coordination, extending signature management across multiple UAVs via a decentralized consensus mesh to synchronize aggregate radar cross-sections, inter-vehicle acoustic phase offsets, and collective RF emission burst schedules. Operators are provided with five distinct Mission Mode Profiles—Silent, ISR, Transit, EW, and Strike—allowing them to tailor countermeasure activation levels according to varying mission phases and operational risks. Finally, the invention encompasses several alternative embodiments, including the integration of a recurrent neural network for predictive threat modeling, hierarchical multi-swarm coordination, autonomous mission-persistent target databases, directed self-emission countermeasures for localized jamming, and a single-domain priority mode designed specifically for size, weight, and power (SWaP) constrained platforms.

Further detailing the system's precise operations, the Target State Vector (TSV) is specifically structured to encode the bearing, range, type, confidence, and lethality for all active targets. This multi-domain target characterization data is rapidly shared across all members of a UAV swarm via a dedicated broadcast protocol within 10 milliseconds of detection. To ensure seamless simultaneous operation, the constraint satisfaction method automatically detects and resolves specific physical conflicts, including plasma sheath and RF emission conflicts, rotor phase and flight stability constraints, thermoelectric cooling and power budget limitations, LPI scheduling and EW beamforming frame synchronization constraints, and adaptive skin panel and plasma sheath surface isolation constraints. Finally, the swarm-level collective coordination is enhanced through aggregate signature verification, which includes the transmission of a Capability Advisory Message to a ground control station.

### BRIEF DESCRIPTION OF DRAWINGS

FIG. 1 is a master system architecture diagram of the Unified Multi-Domain Signature Management System showing all five sensor inputs, the central MDSMS controller comprising Target Fusion Engine, Signature Priority Manager, and Constraint Satisfaction Solver, the five countermeasure subsystem outputs, closed-loop feedback paths, and the optional GCS interface.

FIG. 2 is a functional block diagram of the Target Fusion Engine showing multi-modal detection inputs, the IMM-EKF multi-hypothesis tracker, target classifier, Target State Vector structure, and Domain Activation Controller.

FIG. 3 is a target-to-domain priority matrix and resource allocation diagram for the Signature Priority Manager, including the multi-target conflict resolution algorithm and power budget allocation illustration.

FIG. 4 is a diagram of the Radar/RCS Management Subsystem showing the segmented plasma electrode layout on a representative UAV airframe, selective electrode activation based on target radar bearing, and the Formation RCS Optimizer algorithm.

FIG. 5 is a diagram of the Acoustic Management Subsystem showing shape-memory alloy blade morphing cross-sections for both nominal and morphed trailing edge profiles, multi-rotor phase synchronization geometry, and the closed-loop acoustic control architecture.

FIG. 6 is a diagram of the Infrared Signature Management Subsystem showing the thermoelectric heat redistribution network from motor hot-spots to distributed radiator panels, adaptive emissivity control panel layout, and the real-time IR background matching control loop.

FIG. 7 is a diagram of the RF/EM Emission Management and Visual Stealth Subsystems, showing the LPI emission scheduling timeline, frequency agility and covert channel protocols, adaptive skin panel control architecture, and cross-domain coordination constraints.

FIG. 8 is a mathematical formulation diagram for the Constraint Satisfaction Solver, showing the multi-domain optimization objective function, decision variable vector, constraint categories, ADMM decomposition algorithm, and solver performance characteristics.

FIG. 9 is a swarm-level signature coordination diagram showing a six-node swarm example with domain activation status per node, collective target context, coordination message types, and swarm-level performance metrics.

FIG. 10 is a signature verification and closed-loop feedback architecture diagram showing all five verification sensor systems, the signature error controller algorithm, and measured performance data across all domains.

FIG. 11 is a mission mode profile diagram showing the five operator-selectable configurations (SILENT, ISR, TRANSIT, EW SUPPORT, STRIKE) with domain activation levels, power consumption estimates, and mode switching characteristics.

### DESCRIPTION

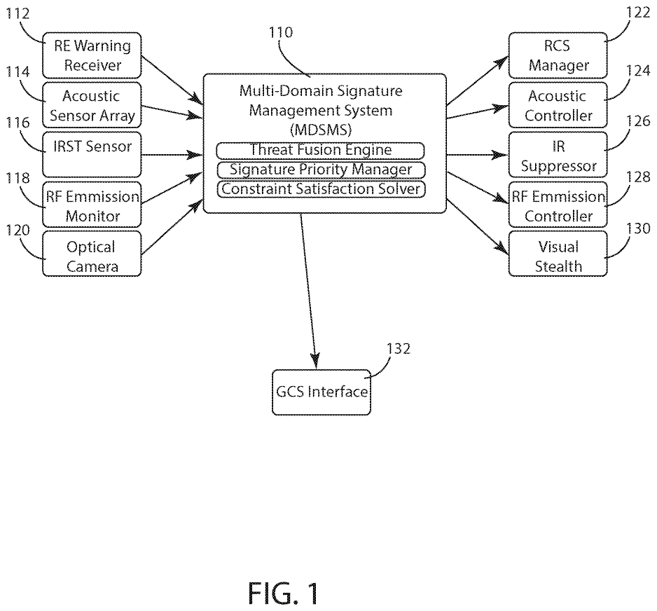

FIG. 1 is a master system architecture diagram illustrating the unified multi-domain signature management system. At the core of this architecture is the Multi-Domain Signature Management System (MDSMS) 110. The MDSMS 110 serves as the central controller and incorporates three primary processing modules: a Threat Fusion Engine, a Signature Priority Manager, and a Constraint Satisfaction Solver.

The MDSMS 110 receives multi-modal sensor data from five distinct input receivers, which continuously monitor the surrounding environment across all signature domains. These inputs include an RE Warning Receiver 112 for detecting radar illumination and RF signals, and an Acoustic Sensor Array 114 for monitoring propulsion noise and external acoustic targets. Additionally, an IRST Sensor 116 tracks thermal emissions, an RF Emmission Monitor 118 analyzes self-generated radio frequency spectra, and an Optical Camera 120 assesses visual contrast and detects the physical airframe against the sky background. Within the MDSMS 110, the Threat Fusion Engine processes the incoming data from these five sensor modalities to generate a real-time target state vector. Using this vector, the Signature Priority Manager allocates constrained power resources across the signature domains, while the Constraint Satisfaction Solver determines a jointly optimal countermeasure operating point that resolves cross-domain physical coupling constraints.

Operating under the unified closed-loop control of the MDSMS 110, the system outputs coordinated commands to five domain-specific countermeasure subsystems. These comprise an RCS Manager 122 to actively manage and reduce the radar cross-section, an Acoustic Controller 124 to deploy countermeasures that minimize acoustic emissions, and an IR Suppressor 126 to manage infrared thermal signatures. Furthermore, an RF Emmission Controller 128 implements low probability of intercept protocols to govern radio frequency emissions, and a Visual Stealth 130 subsystem mitigates visual and optical contrast. Finally, the architecture includes a communication pathway to a GCS Interface 132, which provides optional connectivity to a ground control station.

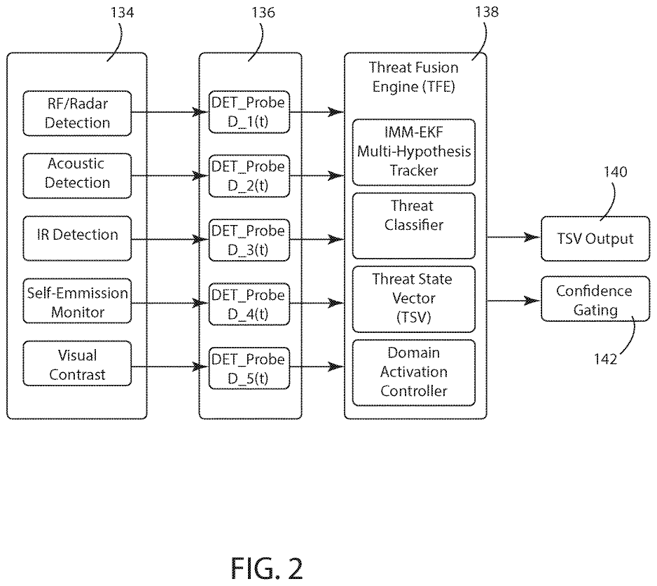

FIG. 2 illustrates a functional block diagram of the Threat Fusion Engine (TFE) 138, which serves to integrate multi-modal sensor data for unified signature management. The system receives detection inputs from a primary sensor suite 134 comprising five distinct modalities: RF/Radar Detection, Acoustic Detection, IR Detection, a Self-Emmission Monitor, and Visual Contrast monitoring. Signals from these diverse sensor modalities are passed to an intermediate processing block 136 consisting of respective detection probes designated as DET_Probe D_1(t), DET_Probe D_2(t), DET_Probe D_3(t), DET_Probe D_4(t), and DET_Probe D_5(t). These synchronized probe streams are subsequently fed into the central Threat Fusion Engine 138. Within the TFE 138, a probabilistic fusion architecture processes the data utilizing an IMM-EKF Multi-Hypothesis Tracker alongside a Threat Classifier. This tracking and classification framework maintains state estimates to compile a comprehensive Threat State Vector (TSV). The engine 138 also incorporates a Domain Activation Controller, which leverages detection certainty levels to manage countermeasure triggering. Finally, the processing within the Threat Fusion Engine 138 generates two separate data streams: a direct TSV Output 140 that broadcasts the real-time, multi-domain target characterization, and a Confidence Gating signal 142 utilized to apply appropriate thresholds before activating downstream signature management subsystems.

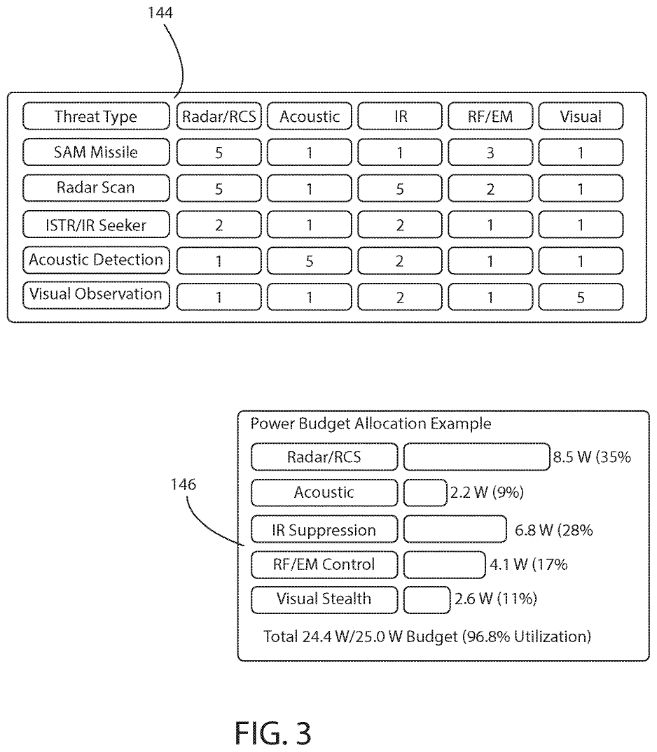

FIG. 3 illustrates the target-to-domain priority matrix 144 and a power budget allocation example 146 utilized by the Signature Priority Manager. The priority matrix 144 is a grid that maps specific threat types—such as SAM Missile, Radar Scan, ISTR/IR Seeker, Acoustic Detection, and Visual Observation—to required activation priority levels across five signature domains. These priority levels dictate the urgency and resource allocation for the Radar/RCS, Acoustic, IR, RF/EM, and Visual countermeasure subsystems. For instance, a SAM Missile threat assigns a top priority of 5 to the Radar/RCS domain and a 3 to the RF/EM domain, while leaving others at 1. Alternatively, an Acoustic Detection threat prioritizes the Acoustic domain with a level of 5. The power budget allocation example 146 demonstrates how the system distributes a constrained power supply across these domains based on the derived multi-target priorities. In this specific scenario, the system utilizes 96.8% of a 25.0 W total budget, expending 24.4 W. The detailed breakdown allocates 8.5 W, or 35%, to Radar/RCS; 2.2 W, or 9%, to Acoustic; 6.8 W, or 28%, to IR Suppression; 4.1 W, or 17%, to RF/EM Control; and 2.6 W, or 11%, to Visual Stealth. This dynamic distribution ensures that the most critical countermeasure domains receive necessary power during complex, multi-threat engagements.

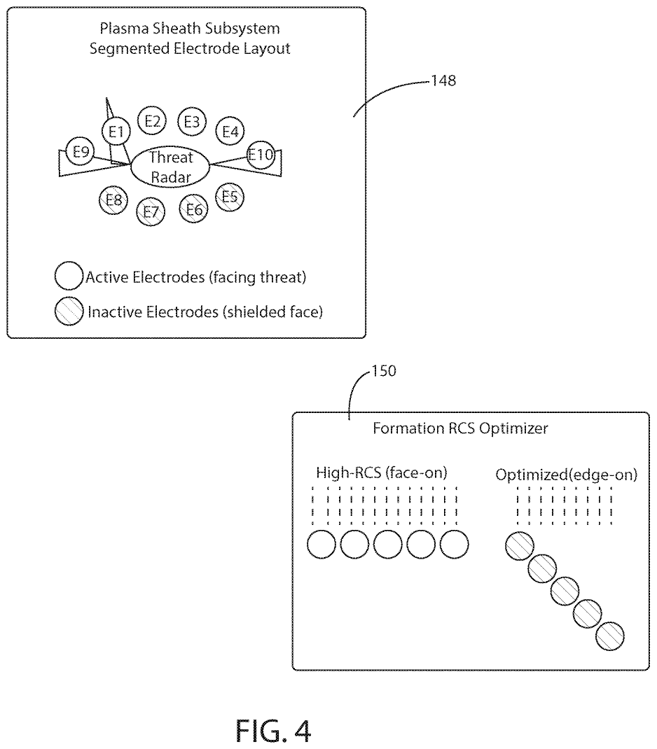

FIG. 4 illustrates the two complementary mechanisms of the Radar/RCS Management Subsystem. The upper section displays the Plasma Sheath Subsystem Segmented Electrode Layout 148, which features an airframe configuration equipped with ten independently controllable electrode segments, designated E1 through E10. To manage power consumption efficiently, the subsystem selectively activates only the specific electrodes directly facing the incoming threat radar, depicted as empty circles. Meanwhile, the electrodes on the shielded face of the airframe, shown as hatched circles, remain inactive. The lower section details the Formation RCS Optimizer 150, which governs swarm-level collective radar cross-section management. This optimizer calculates a rotational angle to transition a multi-UAV swarm from a vulnerable, high-RCS face-on geometry into an optimized, edge-on configuration. By physically realigning the swarm's collective aspect angle relative to the incoming radar signals, the overall radar signature of the formation is significantly minimized.

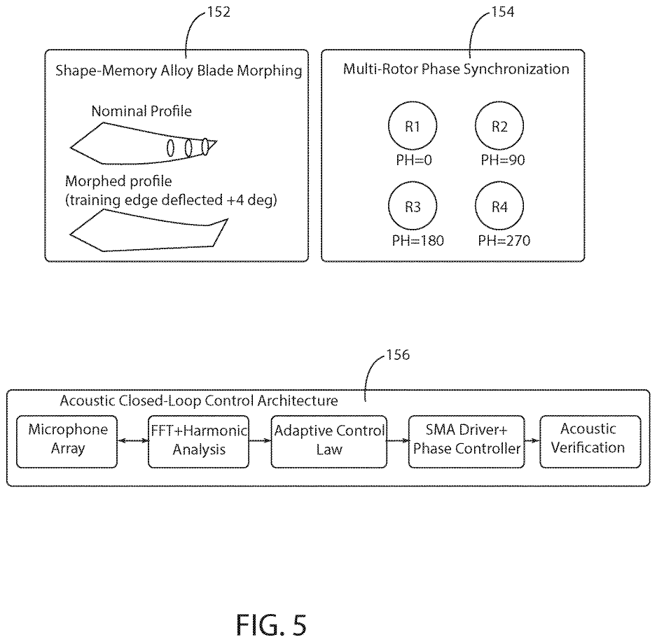

FIG. 5 details the Acoustic Management Subsystem, illustrating two primary mechanisms for acoustic reduction along with its continuous feedback loop. The Shape-Memory Alloy Blade Morphing module 152 showcases a blade's cross-section in a standard Nominal Profile alongside a Morphed profile, where the trailing edge is actively deflected by +4 degrees to alter the blade's aerodynamics. Concurrently, the Multi-Rotor Phase Synchronization component 154 demonstrates collective noise cancellation across a multi-rotor setup. It displays four distinct rotors (R1, R2, R3, and R4) operating with deliberately staggered phase offsets of PH=0, PH=90, PH=180, and PH=270, respectively, enabling destructive acoustic interference. These mechanisms are directly governed by the Acoustic Closed-Loop Control Architecture 156. This control architecture begins with a Microphone Array that captures real-time acoustic data, passing it to an FFT+Harmonic Analysis stage. An Adaptive Control Law processes this analysis to compute optimal corrections, subsequently directing the SMA Driver+Phase Controller to dynamically adjust the physical hardware. Finally, an Acoustic Verification step assesses the resulting acoustic output, continuously closing the control loop to ensure optimal real-time signature mitigation.

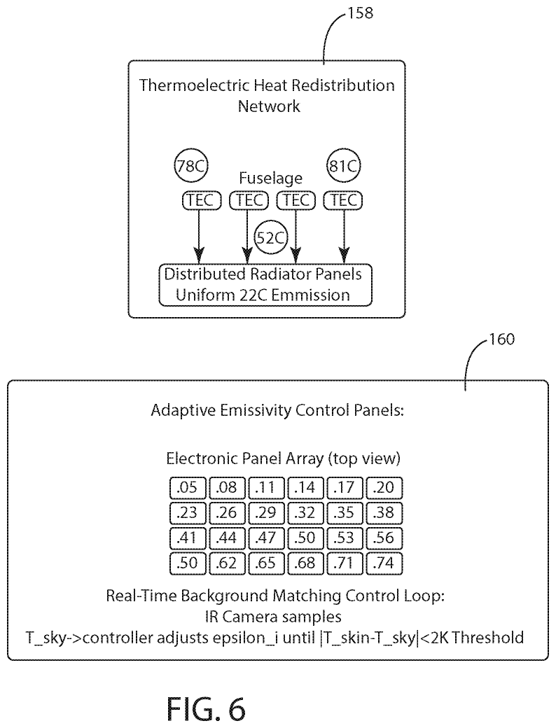

FIG. 6 illustrates the two primary components of the Infrared Signature Management Subsystem. The upper section depicts the Thermoelectric Heat Redistribution Network 158, which actively manages point-source thermal emissions to eliminate highly detectable hot spots. As shown, significant localized heat sources on the fuselage, operating at elevated temperatures such as 78 °C, 81 °C, and 52 °C, are thermally routed through thermoelectric coolers (TEC). These TEC modules redistribute the thermal energy down to Distributed Radiator Panels to achieve a uniform 22 °C emission across the airframe surface. The lower section details the Adaptive Emissivity Control Panels 160, featuring an Electronic Panel Array viewed from the top. This array consists of multiple zones that dynamically adjust their infrared emissivity values, shown ranging from .05 to .74, to proactively blend the airframe with its surrounding environment. This mechanism is governed by a Real-Time Background Matching Control Loop wherein an IR Camera samples the background sky temperature. Utilizing this data, the subsystem's controller subsequently adjusts the emissivity (epsilon_i) of each specific panel until the absolute difference between the apparent skin temperature, and the sky temperature is minimized below a strict 2 Kelvin threshold (|T_skin−T_sky|<2K Threshold).

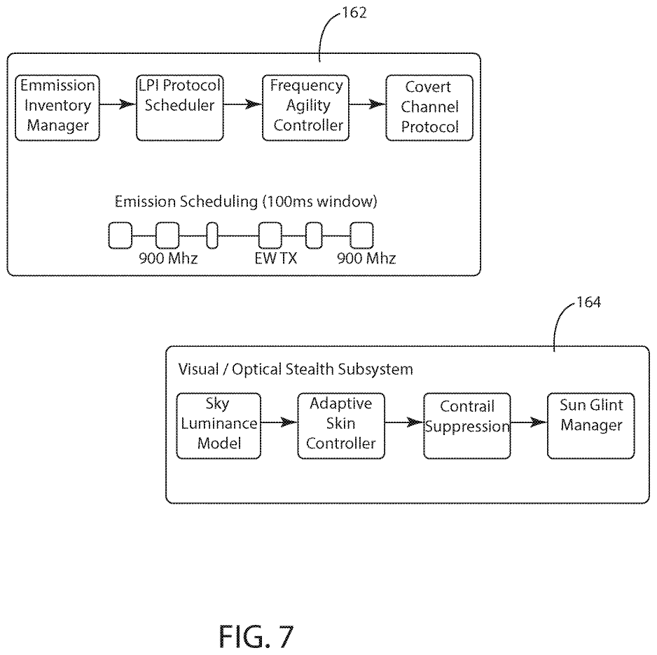

FIG. 7 illustrates the operational pipelines for two distinct signature management subsystems. The upper section details the RF/EM Emission Management Subsystem 162. This subsystem minimizes the platform's radio frequency footprint through a sequential process that begins with an Emmission Inventory Manager, which actively catalogs all onboard emitters. This inventory data is fed into an LPI Protocol Scheduler, followed by a Frequency Agility Controller, and concludes with a Covert Channel Protocol module. Below this main pipeline, an Emission Scheduling diagram demonstrates a 100 ms window utilizing burst-mode transmission to evade detection. This timeline shows short, discrete communication bursts—specifically labeled 900 Mhz and EW TX—separated by strategic periods of radio frequency silence. The lower section displays the Visual/Optical Stealth Subsystem 164, which is designed to mitigate the vehicle's physical visibility against its background. Its control pipeline starts with a Sky Luminance Model that provides environmental baseline data to an Adaptive Skin Controller, which dynamically adjusts the airframe's surface reflectance. The visual stealth process further incorporates a Contrail Suppression module to actively disrupt visible condensation trails, ending with a Sun Glint Manager that guides platform attitude adjustments to avoid highly visible specular reflections.

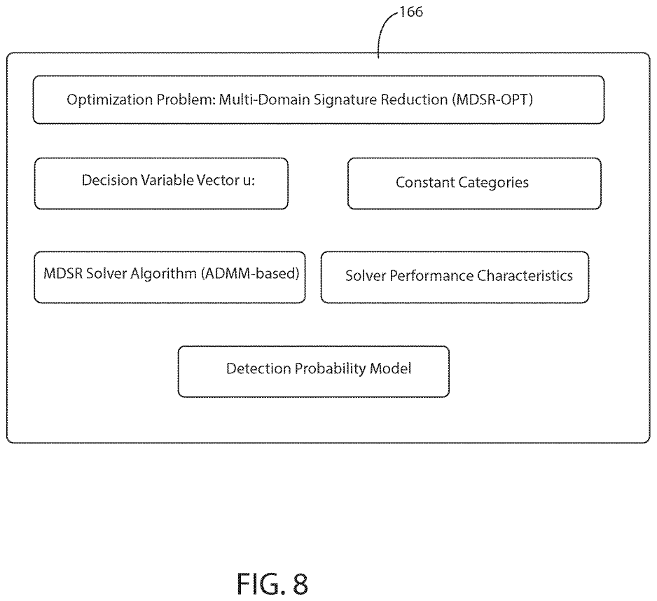

FIG. 8 presents a mathematical formulation diagram for the Constraint Satisfaction Solver, denoted overall by reference numeral 166. At its core, the diagram outlines the Optimization Problem: Multi-Domain Signature Reduction (MDSR-OPT), which functions to calculate a jointly optimal countermeasure operating point across all five signature domains simultaneously. The inputs for this optimization are defined by the Decision Variable Vector u, comprising domain-specific sub-vectors that dictate settings such as plasma electrode activation, rotor phase offsets, and emission burst schedules. These variables are assessed against a Detection Probability Model, which utilizes a logistic function based on signal-to-noise ratios to estimate the likelihood of the platform's detection by adversary sensors. The optimization is bound by specific limits, labeled in the diagram as Constant Categories, representing the cross-domain physical coupling constraints that must be satisfied. To process this complex formulation, the system employs the MDSR Solver Algorithm (ADMM-based), leveraging the Alternating Direction Method of Multipliers to decompose the coupled problem into domain-separable sub-problems that are solved in parallel. Finally, the diagram notes Solver Performance Characteristics, highlighting the algorithm's capability to converge on an optimal solution within mere milliseconds to support continuous, real-time signature management.

The Constraint Satisfaction Solver (CSS) solves an optimization problem known as the Multi-Domain Signature Reduction Optimization (MDSR-OPT). The objective is to minimize the function J(u):
J(u)=\sum_{d\in\{\text{RCS, Acoustic, IR, RF, Visual}\}} w_d\cdot
P_{\text{detect},d}(u_d,\text{TSV})

### Where:

u_d is the decision variable vector for domain d.
w_d is the target-weighted importance of domain d, derived from the Signature Priority Manager's (SPM) priority allocation.
P_{\text{detect},d}(u_d,\text{TSV}) is the estimated detection probability for domain d, based on the countermeasure state and the current Target State Vector (TSV).

This detection probability is modeled using the following logistic function:
P_{\text{detect}, d}=\sigma\Big(\alpha_d\cdot\big[SNR_d(u_d)−SNR_{\text{threshold},d}\big]\Big)
Where:
SNR_d(u_d) is the domain-specific signal-to-noise ratio as a function of the countermeasure state.
SNR_{\text{threshold},d} is the baseline SNR required for nominal detection.
\alpha_d is the detection sensitivity parameter, calibrated for the specific target sensor modality.

The decision variable vector comprises five domain-specific sub-vectors. The Radar/RCS domain vector encodes the plasma electrode activation bitmask—using 10 bits for the ten electrode segments—and the formation rotation angle for swarm configurations. The Acoustic domain vector encodes the trailing edge deflection angles for blade morphing across all rotor blades, alongside the rotor phase offset set for multi-rotor phase synchronization. The Infrared domain vector encodes the Peltier module current levels for the thermoelectric redistribution network and the emissivity set-points for all 64 adaptive skin panel zones. The Radio Frequency domain vector encodes the burst schedule, including timing, duration, and inter-burst interval, as well as frequency hop pattern parameters and the burst power level. Finally, the Visual/Optical domain vector encodes the panel voltage map for the electrochromic skin array, the contrail suppressor actuator state, and the sun glint avoidance orientation constraint.

The MDSR-OPT problem is solved using the Alternating Direction Method of Multipliers (ADMM). This first-order convex optimization algorithm efficiently decomposes the coupled, multi-domain problem into domain-separable sub-problems that can be solved in parallel. To couple these sub-problems, the ADMM algorithm introduces a global consensus variable and augmented Lagrangian multipliers. At each iteration, each domain solves its local sub-problem to minimize its objective function alongside the augmented Lagrangian coupling term. Subsequently, the global consensus variable is updated using the newly computed domain solutions, and the Lagrangian multipliers are updated proportionally to any constraint violations. This decomposition is highly efficient for the MDSR-OPT structure because the cross-domain coupling constraints appear as linear constraints on the decision variable vector, allowing them to be naturally resolved by the Lagrangian coupling terms without requiring modifications to the domain-specific objective functions.

In the preferred embodiment, which utilizes an ARM Cortex-A53 embedded hardware platform at 1.2 GHz, each ADMM iteration requires approximately 0.5 milliseconds of computation. This rapid computation yields highly efficient convergence times. For warm-started problems involving incremental target changes, the algorithm converges to within 2% of the global optimum in 3 to 8 iterations, resulting in total solution times of 1.5 to 4 milliseconds. For cold-started problems involving new target appearances, the algorithm converges in fewer than 20 iterations, resulting in total solution times of less than 10 milliseconds. Both of these scenarios fall comfortably within the 20-millisecond Constraint Satisfaction Solver budget required to maintain a 50 Hz update rate.

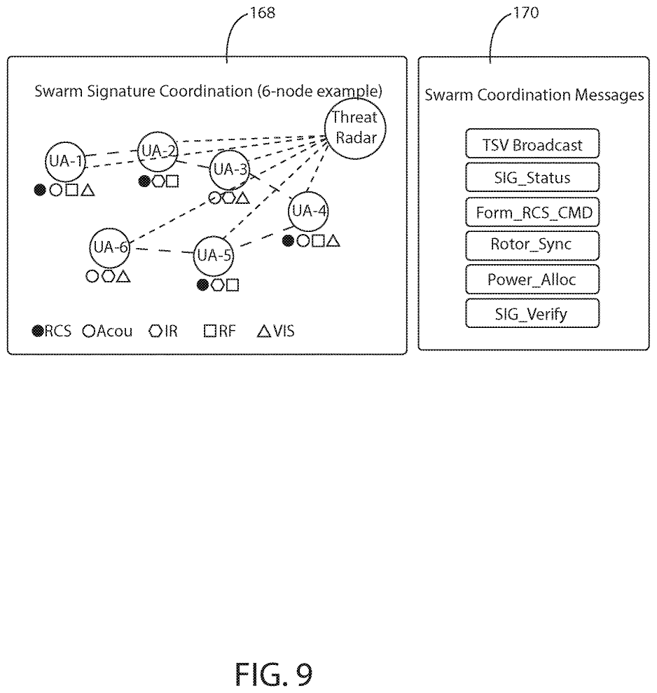

FIG. 9 illustrates a swarm-level signature coordination diagram, depicting a six-node swarm configuration alongside the required communication protocols for collective stealth management. This architecture extends multi-domain signature management from isolated single-vehicle operations to a cooperative, swarm-level framework utilizing a decentralized consensus mesh infrastructure.

The left section of the diagram, designated by reference numeral 168, maps the physical and operational states for the swarm signature coordination. It features six distinct unmanned aerial vehicles, denoted as UA-1 through UA-6, navigating collectively in the presence of a primary detection source identified as a Threat Radar. Beneath the formation, a symbology legend specifies the domain activation status for each node across the five managed signature profiles: radar cross-section (RCS), acoustic (Acou), infrared (IR), radio frequency (RF), and visual (VIS) domains. Each vehicle activates a tailored subset of these countermeasures corresponding to its geometric exposure and the collective target context.

The right section of the diagram, designated by reference numeral 170, enumerates the specific Swarm Coordination Messages broadcast over the peer-to-peer network to synchronize countermeasure deployment. The TSV Broadcast disseminates the Target State Vector, ensuring all nodes receive shared multi-modal target characterization data instantly upon detection. For active collective stealth maneuvers, the Form_RCS_CMD message commands simultaneous positional adjustments across the nodes to achieve an optimal formation geometry that minimizes the aggregate radar cross-section. To manage acoustic emissions, the Rotor_Sync message transmits precise inter-vehicle phase offsets, synchronizing the rotor operations of all members to induce destructive acoustic interference at the target's bearing. Radio frequency emissions are managed via the SIG_Status message, which coordinates transmission burst schedules among the nodes to prevent the formation of detectable aggregate emission patterns. Finally, the Power_Alloc and SIG_Verify messages facilitate dynamic resource distribution across the nodes and provide closed-loop verification of the achieved aggregate signature reduction.

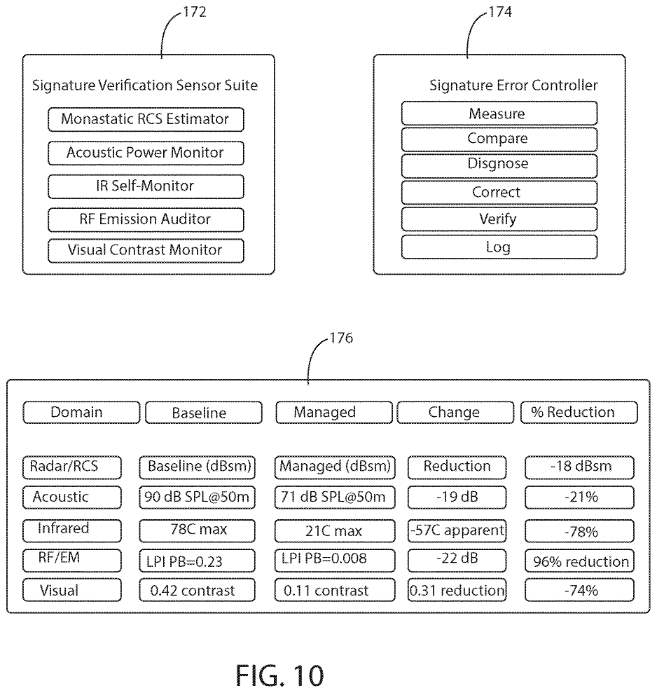

FIG. 10 illustrates the architecture and performance metrics of the signature verification and closed-loop feedback system. The system incorporates a Signature Verification Sensor Suite 172, which comprises five dedicated verification subsystems: a monostatic RCS estimator, an acoustic power monitor, an IR self-monitor, an RF emission auditor, and a visual contrast monitor. These sensors continuously measure the achieved signature reduction in each respective domain and provide independent feedback to the Signature Error Controller 174. The controller 174 executes a continuous closed-loop feedback process through sequential steps to measure, compare, diagnose, correct, verify, and log signature errors, allowing the system to dynamically adjust countermeasure commands. Additionally, the figure includes a performance data table 176 that summarizes the baseline, managed, change, and percentage reduction metrics across all five signature domains. The table 176 highlights the system's efficacy, detailing achievements such as an 18 dBsm reduction in the radar/RCS domain, decreasing the acoustic signature from a baseline of 90 dB SPL at 50 m to a managed 71 dB SPL at 50 m, and reducing the maximum infrared temperature from 78 °C to a managed 21 °C. Furthermore, it demonstrates a 96% reduction in RF/EM intercept probability (lowering the baseline from 0.23 to 0.008) and a 74% reduction in visual contrast, collectively validating the comprehensive signature reduction capabilities of the multi-domain system.

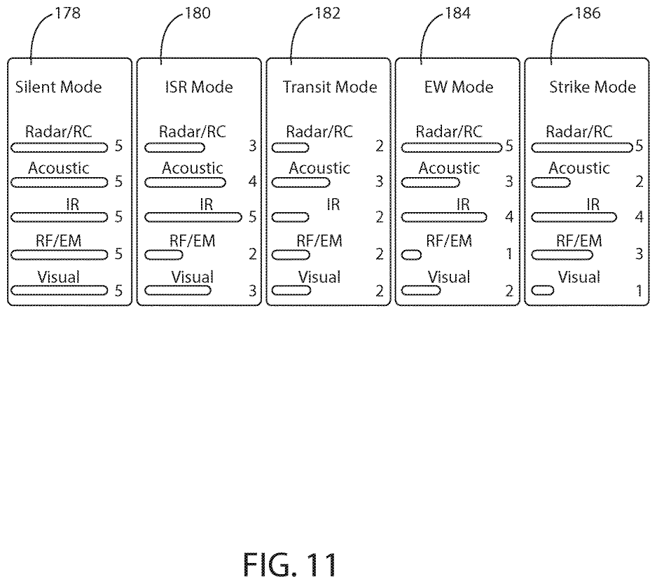

FIG. 11 illustrates five operator-selectable mission mode profiles for the multi-domain signature management system, detailing countermeasure activation levels on a scale of 1 to 5 across the Radar/RC, Acoustic, IR, RF/EM, and Visual domains. Silent Mode 178 configures all five signature domains to operate at their maximum activation level of 5, consuming the highest power to provide maximum multi-domain stealth during critical mission phases. ISR Mode 180 is tailored for long-endurance surveillance where exposure time increases risk, heavily prioritizing IR countermeasures at level 5 and Acoustic at level 4, while maintaining moderate Radar/RC and Visual activation at level 3 and lower RF/EM activation at level 2. Transit Mode 182 is designed for en-route cruising with balanced, power-conserving operations, setting Acoustic to level 3 and all other domains to a moderate level 2. EW Mode 184 supports active electronic warfare by maintaining maximum Radar/RC activation at level 5 and high IR coverage at level 4, but intentionally relaxes RF/EM emission constraints to level 1 to permit active RF transmissions, alongside moderate Acoustic and Visual levels at 3 and 2, respectively. Strike Mode 186 supports fast ingress scenarios where terminal-phase threats are highest by prioritizing Radar/RC at level 5 and IR at level 4, paired with moderate RF/EM at level 3, low Acoustic at level 2, and minimal Visual stealth at level 1.

The disclosed multi-domain signature management system (MDSMS) encompasses several alternative embodiments that expand its operational capabilities and adaptability. In a first alternative embodiment, the Target Fusion Engine is enhanced with a recurrent neural network trained on historical integrated air defense systems (IADS) engagement data. This predictive capability allows the Signature Priority Manager to anticipate adversary sensor activations and preemptively deploy countermeasures, effectively shifting the system from a reactive to a proactive defense posture.

A second embodiment scales the collective signature coordination into a hierarchical, multi-swarm architecture. This enables multiple independent swarms—each operating an individual MDSMS instance—to cooperatively optimize formation geometries and electromagnetic emissions across a combined multi-swarm force.

To further refine target models over time, a third embodiment incorporates an autonomous, mission-persistent target database. By recording the geographic locations, sensor modalities, and detection thresholds of previously encountered adversary systems, this configuration leverages Bayesian updating to achieve progressively precise countermeasure calibration against specific IADS configurations.

A fourth embodiment introduces a directed self-emission countermeasure capability. Here, the RF/EM subsystem exploits distributed electronic warfare beamforming to transmit calibrated noise in a narrow beam directly toward an adversary electronic support measures (ESM) receiver, effectively generating a directed jamming signal that degrades the adversary's ability to accurately geolocate the platform.

For platforms with severely constrained size, weight, and power (SWaP) budgets, a fifth embodiment provides a single-domain priority mode. While this configuration sacrifices simultaneous multi-domain operation, it significantly reduces power and hardware demands by activating only a single countermeasure domain at any given time—determined by the highest-priority target in the current Target State Vector. This reduced-SWaP mode seamlessly switches between domains in under 100 milliseconds while retaining the core functionalities of the multi-modal target detection, the priority allocation logic, and the closed-loop verification systems.

1. A unified multi-domain signature management system for an unmanned aerial vehicle (UAV), the system comprising:
a Target Fusion Engine (TFE) hardware module coupled to a plurality of sensor modalities; and
a Signature Priority Manager (SPM) module in electrical communication with the TFE; and
a Constraint Satisfaction Solver (CSS) processor connected to the SPM; and
at least three domain-specific countermeasure hardware subsystems selected from a Radar/RCS Management Subsystem, an Acoustic Management Subsystem, an Infrared Management Subsystem, an RF/EM Emission Management Subsystem, and a Visual Stealth Subsystem; and
a Signature Verification Module (SVM) comprising domain-specific verification sensors; wherein
the TFE receives signals from the sensor modalities monitoring at least three of radar cross-section, acoustic emission, infrared emission, radio frequency emission, and visual contrast to produce a real-time Target State Vector (TSV) encoding bearing, range, target type, detection confidence, and estimated lethality, the SPM allocates countermeasure activation levels across a plurality of signature domains by applying a target-to-domain priority matrix and solving a power-constrained resource allocation problem when required power exceeds an available budget, the CSS computes, at a rate of at least 25 Hz, a jointly optimal countermeasure operating point across all active signature domains subject to cross-domain physical coupling constraints, and the SVM measures achieved signature reduction to provide closed-loop feedback to the active countermeasure subsystems and the SPM.

2. The system of claim 1 further comprising:
an Interacting Multiple Model Extended Kalman Filter (IMM-EKF) integrated within the Target Fusion Engine; wherein the IMM-EKF maintains a bank of parallel Kalman filters under different target motion models and assigns Bayesian model probabilities updated at each measurement cycle.

3. The system of claim 1 further comprising:
a segmented plasma electrode array having at least eight independently controllable electrode segments distributed across a UAV airframe within the Radar/RCS Management Subsystem; wherein the electrode segments facing the target radar bearing identified from the TSV are selectively activated while other segments remain inactive, thereby reducing total power consumption by at least 60% relative to full-coverage activation.

4. The system of claim 1 further comprising:
shape-memory alloy actuators embedded in rotor blade trailing edges within the Acoustic Management Subsystem; wherein the actuators deflect trailing edge geometry in the range of plus or minus 8 degrees under closed-loop control of a Filtered-X Least Mean Squares algorithm to minimize measured blade passing frequency harmonics.

5. The system of claim 4 further comprising:
a multi-rotor phase synchronization controller coupled to individual rotor commutation timing circuits within the Acoustic Management Subsystem; wherein
the phase synchronization controller applies differential phase offsets to individual rotor commutation timing signals to produce destructive acoustic interference at the target acoustic bearing identified from the TSV.

6. The system of claim 1 further comprising:
a thermoelectric heat redistribution network having heat pipes and Peltier modules connecting motor nacelles and a battery bay to distributed radiator panels within the Infrared Management Subsystem; wherein
the thermoelectric heat redistribution network minimizes the variance of the airframe surface temperature distribution rather than minimizing total thermal emission.

7. The system of claim 6 further comprising:
an array of at least 32 electrochromic panel zones covering an outer airframe surface; wherein
each electrochromic panel zone provides independently adjustable infrared emissivity in the range of 0.05 to 0.95 and is controlled to minimize the difference between apparent surface temperature and measured sky background infrared radiance.

8. The system of claim 1 further comprising:
a burst-mode transmitter and a frequency-hopping spread spectrum transceiver within the RF/EM Emission Management Subsystem;
wherein
the RF/EM Emission Management Subsystem implements low probability of intercept protocols comprising burst-mode transmission with a maximum burst duration of 10 milliseconds, frequency hopping at a configurable hop rate, and steganographic covert channel encoding.

9. The system of claim 1 further comprising:
an array of visible-band electrochromic panels covering outer airframe surfaces, a contrail suppression system having airflow baffles around rotor tips, and a sun glint management module within the Visual Stealth Subsystem; wherein
the electrochromic panels provide independently adjustable visible-band reflectance, the airflow baffles actuate in high-humidity conditions, and the sun glint management module provides orientation guidance to a flight control system.

10. The system of claim 1 further comprising:
an embedded flight management computer hosting the Constraint Satisfaction Solver; wherein
the Constraint Satisfaction Solver implements an ADMM algorithm with warm-starting from a previous solution, achieving convergence in 3-8 iterations for incremental target changes and completing each optimization cycle within 10 milliseconds.

11. The system of claim 1 further comprising:
memory storing cross-domain physical coupling constraint data accessible by the Constraint Satisfaction Solver; wherein the CSS automatically detects and resolves constraints comprising at least a plasma electrode activation exclusion zone preventing RF antenna operation on co-located surface segments, a rotor phase deviation bound limiting phase perturbation to within a flight-stability margin, a thermoelectric power budget constraint, an LPI burst schedule synchronization constraint with EW Beamforming frame timing, and an adaptive skin panel high-voltage isolation constraint when plasma is active on adjacent surfaces.

12. The system of claim 1 further comprising:
a user interface storing five operator-selectable mission mode profiles; wherein
the profiles comprise a SILENT mode activating all domains at maximum power, an ISR mode prioritizing infrared and acoustic domains, a TRANSIT mode applying balanced moderate activation at 50% power, an EW SUPPORT mode relaxing RF emission constraints to permit active EW operations, and a STRIKE mode prioritizing radar and infrared domains.

13. The system of claim 1 further comprising:
a swarm-level collective signature coordination network including a Formation RCS Optimizer, a swarm-wide rotor phase synchronization system, and a coordinated RF emission scheduler; wherein the Formation RCS Optimizer computes an optimal swarm formation rotation angle minimizing aggregate collective radar cross-section with respect to the target radar bearing, the rotor phase synchronization system computes inter-vehicle rotor phase offsets for collective acoustic cancellation, and the coordinated RF emission scheduler manages aggregate swarm emission patterns as a collective stealth property.

14. The system of claim 13 further comprising:
a BFT-confirmed consensus mechanism network link connecting the Formation RCS Optimizer to members of the swarm; wherein the Formation RCS Optimizer broadcasts formation updates via the BFT-confirmed consensus mechanism to achieve swarm-wide formation reconfiguration within 200 milliseconds of a target bearing change.

15. The system of claim 1 further comprising:
at least five verification hardware subsystems within the Signature Verification Module, including a monostatic RCS estimator with a self-illuminating UWB pulse emitter, an onboard microphone array, an IRST sensor in self-monitoring mode, a spectrum analyzer, and a downward-looking electro-optical camera; wherein the verification hardware subsystems measure monostatic RCS, acoustic power, IR self-monitoring profiles, RF emissions, and visual contrast to quantify and audit achieved signature reduction.

16. The system of claim 1 further comprising:
an operator-configurable target-to-domain priority matrix database connected to the SPM; wherein
the SPM applies a 5×5 target-to-domain priority matrix encoding a priority level from 1 to 5 for each combination of five target types and five signature domains, the matrix being configurable before flight to reflect the specific target profile of an operational area.

17. The system of claim 1 further comprising:
a fractional knapsack allocation module within the SPM; wherein the fractional knapsack allocation module activates when the sum of required countermeasure powers across all active domains exceeds an available power budget, and selects a combination of domain activation levels that maximizes total target mitigation value subject to the power budget constraint.

18. A method for managing a plurality of electromagnetic and physical signatures of an unmanned aerial vehicle simultaneously, the method comprising:
receiving sensor data from a plurality of distinct sensor modalities, each monitoring a different signature domain selected from radar cross-section, acoustic, infrared, radio frequency emission, and visual contrast; and
fusing the sensor data in a multi-modal tracking algorithm to produce a real-time Target State Vector encoding the bearing, classification, confidence, and lethality of all active targets; and
allocating countermeasure resources across all active signature domains using a power-constrained priority assignment derived from a target-to-domain priority matrix; and
computing a jointly feasible countermeasure operating point for all active signature domains simultaneously using an Alternating Direction Method of Multipliers decomposition that resolves cross-domain physical coupling conflicts automatically; and
commanding all domain-specific countermeasure subsystems to the computed operating point; and
measuring achieved signature reduction in each domain through closed-loop verification sensors; and
adjusting countermeasure commands based on measured signature error until all domains achieve target reduction levels within a configurable tolerance.

19. A constraint satisfaction method for coordinating countermeasures across a plurality of distinct signature reduction domains in an unmanned aerial vehicle, the method comprising:
formulating a multi-domain signature reduction optimization problem having a decision variable vector comprising separate sub-vectors for each active signature domain and an objective function comprising the sum of detection probabilities in each active domain weighted by target severity; and
identifying cross-domain physical coupling constraints comprising at least a plasma sheath activation exclusion zone constraint preventing simultaneous plasma electrode activation and RF antenna transmission on co-located surface regions, a rotor phase deviation bound constraint limiting rotor phase modification to within a flight stability margin, and a total power budget constraint on the aggregate power consumed by all active countermeasure subsystems; and
decomposing the optimization problem into domain-separable sub-problems using an Alternating Direction Method of Multipliers (ADMM) algorithm; and
solving each domain sub-problem in parallel and updating global coupling variables until convergence within a configurable optimality tolerance.

20. A Target State Vector (TSV) data structure embodied on a non-transitory computer-readable medium for unified multi-domain signature management, the data structure comprising:
an azimuth bearing field; and
an elevation angle field; and
an estimated slant range field; and
a three-dimensional velocity field; and
a primary sensor modality target type field; and
a normalized detection confidence field; and
a lethality radius field; and
a domain bitmask field; and
an estimated engagement time field; and
a priority index field; and
a source node identifier field; and
a timestamp field; and
a cryptographic signature field; wherein the fields collectively encode target characteristics, and the TSV data structure is broadcast to all members of a UAV swarm via peer-to-peer mesh communication within 10 milliseconds of target detection for authenticity verification by receiving nodes.
